(19) United States
(12) Patent Application Publication
(10) Pub. No.: US 2018/0022859 A1
(43) Pub. Date: Jan. 25, 2018

(54) IMPROVED LOW-TEMPERATURE IMPACT RESISTANCE IN PTMEG-BASED POLYURETHANE IMPACT MODIFIERS

(71) Applicant: SIKA TECHNOLOGY AG, Baar (CH)

(72) Inventors: Christian KRÜGER, Schlieren (CH); Urs RHEINEGGER, Regensdorf (CH)

(73) Assignee: SIKA TECHNOLOGY AG, Baar (CH)

(21) Appl. No.: 15/549,772

(22) PCT Filed: Feb. 25, 2016
(86) PCT No.: PCT/EP2016/053956

§ 371 Date: Aug. 9, 2017

(30) Foreign Application Priority Data
Mar. 4, 2015 (EP) 15157537.0

(51) Int. Cl. C08G 18/48; C08G 18/10; C08G 65/20; C08G 18/75; C08G 18/78; C08G 18/79; C08G 18/72

(52) U.S. Cl. CPC C08G 18/4854; C08G 18/792; C08G 18/10; C08G 18/725; C08G 18/755; C08G 18/7831; C08G 65/20

(57) ABSTRACT

An impact modifier, which is an isocyanate-terminated polymer, the isocyanate groups of which are partially or completely blocked by reaction with a blocking agent, wherein the isocyanate-terminated polymer is a reaction product of a) one or more polyols including polytetramethylene ether glycol in a fraction of at least 95 wt %, with respect to the total weight of the polyols, and b) two or more polyisocyanates, which include at least one diisocyanate and at least one polyisocyanate having an average isocyanate functionality of 2.5 or more, wherein the molar ratio of isocyanate groups of the one or more diisocyanates to isocyanate groups of the one or more polyisocyanates having an average isocyanate functionality of 2.5 or more lies in the range of 2 to 1 to 20 to 1. The impact modifier is suitable in one-component epoxide resin formulations, one-component epoxide resin glues, but also in two-component epoxide resin formulations.

### TECHNICAL FIELD

The invention relates to impact modifiers for epoxy resin-based adhesives, especially epoxy resin-based structural adhesives.

### STATE OF THE ART

Adhesives for bodywork construction, in the case of 1K (one-component) adhesives, should cure under the customary baking conditions of ideally 30 minutes at 180° C. In the case of 2K (two-component) adhesives, the curing should be effected at room temperature over the course of a few days to about one week; alternatively, an accelerated curing regime, for example 4 h at RT followed by 30 min at 60° C. or 85° C. should be applicable. In addition, they should also be stable up to about 220° C. Further requirements in respect of such a cured adhesive and of the bonding are the assurance of operational reliability both at high temperatures up to about 90° C. and at low temperatures down to about −40° C. Since these adhesives are especially structural adhesives and these adhesives therefore bond structural components, high strength and impact resistance of the adhesive are extremely important.

Conventional epoxy adhesives feature high mechanical strength, especially high tensile strength. In the event of abrupt stress on the bond, conventional epoxy adhesives, however, are usually too brittle and are therefore by no means able to meet the demands, especially from the automotive industry, under crash conditions, where both great tensile stresses and peel stresses occur. What are often inadequate in this regard are particularly the strengths at high temperatures, but especially at low temperatures (e.g. <−10° C.).

An impact modifier, which is also referred to as toughener, is one of the most important formulation constituents in structural adhesives. It has a crucial effect on important parameters such as impact resistance, aging stability, adhesion, and in fact all physical properties.

There is already a wide range of known impact modifiers for epoxy resins. These are mainly liquid copolymers or preformed core-shell particles. An important type of impact modifiers is that of blocked polyurethane toughener polymers as key components for crash-resistant structural adhesives. A particular challenge here lies in the achievement of sufficient impact resistance at low temperatures.

However, the impact resistance, especially the low-temperature impact resistance, which can be achieved with polyurethane tougheners is often insufficient, and so polyurethane toughener polymers are usually used in combination with CTBN (carboxyl-terminated acrylonitrile-butadiene) adducts. One disadvantage here is the relatively high cost of the CTBN adducts used.

### SUMMARY OF THE INVENTION

It is therefore an object of the present invention to provide impact modifiers which overcome the above-described problems with the prior art. More particularly, the intention was to provide impact modifiers for epoxy resin compositions that have good low-temperature impact resistance, making it possible to very substantially avoid the use of specific costly added components and the associated problems.

It has been found that, surprisingly, the partial use of higher-functionality polyisocyanates can distinctly improve the impact resistance, especially the low-temperature impact resistance, of homo-PTMEG-based polyurethane tougheners.

The invention therefore relates to an impact modifier which is an isocyanate-terminated polymer, the isocyanate groups of which have been fully or partly blocked by reaction with a blocking agent, wherein the isocyanate-terminated polymer is a reaction product of
a) one or more polyols comprising polytetramethylene ether glycol in a proportion of at least 95% by weight, based on the total weight of the polyols, and
b) two or more polyisocyanates including at least one diisocyanate and at least one polyisocyanate having a mean isocyanate functionality of 2.5 or more, wherein the molar ratio of isocyanate groups in the diisocyanate(s) to isocyanate groups in the polyisocyanate(s) having a mean isocyanate functionality of 2.5 or more is in the range from 2:1 to 20:1.

The invention achieves improved low-temperature impact resistance or improved low-temperature crash resistance in structural epoxy resin adhesives for PTMEG-based polyurethane tougheners. A distinct improvement was observed in impact peel strengths at −30° C. compared to analogous tougheners based on the strictly difunctional diisocyanates such as HDI and IPDI.

The invention also relates to a process for preparing these impact modifiers, to the use thereof, and to epoxy resin formulations comprising these impact modifiers. Preferred embodiments are reflected in the dependent claims.

### MODE OF EXECUTION OF THE INVENTION

The prefix “poly” in expressions such as polyol or polyisocyanate means that the compound contains two or more of the groups mentioned. A polyol is thus a compound having two or more hydroxyl groups. A polyisocyanate is a compound having two or more isocyanate groups. Accordingly, a diol and a diisocyanate are respectively compounds having two hydroxyl groups and two isocyanate groups.

An isocyanate-terminated polymer is a polymer having isocyanate groups as end groups. In the polymer of the invention, these isocyanate groups are partly or fully blocked.

The isocyanate-terminated polymer is a reaction product of a) one or more polyols comprising polytetramethylene ether glycol in a proportion of at least 95% by weight, based on the total weight of the polyols, and b) two or more polyisocyanates including at least one diisocyanate and at least one polyisocyanate having a mean isocyanate functionality of 2.5 or more. The reaction of polyols and polyisocyanates is generally a customary reaction for formation of polyurethanes. The isocyanate-terminated polymer formed is thus especially an isocyanate-terminated polyurethane polymer.

The polyol(s) for preparation of the isocyanate-terminated polymer include(s) polytetramethylene ether glycol. It is possible to use one or more polytetramethylene ether glycols. Polytetramethylene ether glycol is also referred to as PTMEG. PTMEG can be prepared, for example, by polymerization of tetrahydrofuran, for example via acidic catalysis. The polytetramethylene ether glycols are diols.

Polytetramethylene ether glycols are commercially available, for example the PolyTHF® products from BASF such as PolyTHF®2000, PolyTHF®2500 CO or PolyTHF®3000 CO, or the Terathane® products from Invista B.V.

The OH functionality of the polytetramethylene ether glycol used is preferably in the region of about 2, for example in the range from 1.9 to 2.1. This is the result of the cationic polymerization of the starting monomer tetrahydrofuran.

Advantageous polytetramethylene ether glycols are those having OH numbers between 170 mg/KOH g and 35 mg KOH/g, preferably in the range from 100 mg KOH/g to 40 mg KOH/g, and most preferably 70 to 50 mg KOH/g. Unless stated otherwise, in the present application, the OH number is determined by titrimetric means according to DIN 53240. The hydroxyl number is determined here by acetylation with acetic anhydride and subsequent titration of the excess acetic anhydride with alcoholic potassium hydroxide solution.

With knowledge of the difunctionality, it is possible to use the hydroxyl numbers determined by titrimetric means to determine the OH equivalent weights or mean molecular weight of the polytetramethylene ether glycol used.

Polytetramethylene ether glycols used advantageously in the present invention preferably have a mean molecular weight in the range from 500 to 5000 g/mol, more preferably 1000 to 3000 g/mol and especially preferably in the range from 1500 to 2500 g/mol, especially about 2000 g/mol. The figures are based on the calculation of the molecular weight from the hydroxyl numbers determined by titrimetric means as described above, assuming a functionality of 2 for PTMEG. This method of determination is also typically used by the producers of these polymers.

Based on the total weight of the polyols used for preparation of the isocyanate-terminated polymer, the proportion of polytetramethylene ether glycol is at least 95% by weight and preferably at least 98% by weight. In a preferred embodiment, the polyol(s) are polytetramethylene ether glycol, meaning that polytetramethylene ether glycols are the only polyols used. All the features cited in this application with regard to the impact modifier explicitly apply correspondingly to reaction products where the only polyol used is polytetramethylene ether glycol.

For preparation of the isocyanate-terminated polymer, the polyol used is primarily polytetramethylene ether glycols only. The polymer is therefore a homo-PTMEG-based polymer. However, it is possible if necessary to add at least one further polyol, especially chain extender, such as preferably tetramethylene glycol (TMP) or DOW VORAPEL T5001 (a trifunctional polyether polyol based on polybutylene oxide), in small amounts of less than 5% by weight, preferably less than 2% by weight, based on the total weight of the polyols used. The chain extender is preferably a polyol having a molecular weight of not more than 1500 g/mol, more preferably not more than 1000 g/mol. In this way, it is possible to combine the chain extension on the isocyanate side with a chain extension on the polyol side.

The isocyanate-terminated polymer is obtainable from the reaction of one or more polyols including polytetramethylene ether glycol in a proportion of at least 95% by weight, based on the total weight of the polyols used, with at least two polyisocyanates including at least one diisocyanate and at least one polyisocyanate having a mean isocyanate functionality of 2.5 or more.

It is possible to use one or more diisocyanates. Preference is given to monomeric diisocyanates or dimers thereof. Suitable diisocyanates are, for example, aliphatic, cycloaliphatic, aromatic or araliphatic diisocyanates. These are commercial products. Examples of suitable diisocyanates are methylene diphenyl diisocyanate (MDI), hexamethylene diisocyanate (HDI), toluene diisocyanate (TDI), toluidine diisocyanate (TODD, isophorone diisocyanate (IPDI), trimethylhexamethylene diisocyanate (TMDI), 2,5- or 2,6-bis(isocyanatomethyl)bicyclo[2.2.1]heptane, naphthalene 1,5-diisocyanate (NDI), dicyclohexylmethyl diisocyanate (H₁₂MDI), p-phenylene diisocyanate (PPDI), m-tetramethylxylylene diisocyanate (TMXDI) etc., and dimers thereof.

Preferred diisocyanates are aliphatic or cycloaliphatic diisocyanates, preferably monomeric diisocyanates or dimers thereof. Examples are tetramethylene 1,4-diisocyanate, 2-methylpentamethylene 1,5-diisocyanate, hexamethylene 1,6-diisocyanate (HDI), 2,2,4- and 2,4,4-trimethylhexamethylene 1,6-diisocyanate (TMDI), decamethylene 1,10-diisocyanate, dodecamethylene 1,12-diisocyanate, lysine diisocyanate and lysine ester diisocyanate, cyclohexane 1,3- and 1,4-diisocyanate, 1-methyl-2,4- and -2,6-diisocyanatocyclohexane and any desired mixtures of these isomers (HTDI or H₆TDI), 1-isocyanato-3,3,5-trimethyl-5-isocyanatomethylcyclohexane (=isophorone diisocyanate or IPDI), perhydro-2,4′- and -4,4′-diphenylmethane diisocyanate (HMDI or H₁₂MDI), 1,4-diisocyanato-2,2,6-trimethylcyclohexane (TMCDI), 1,3- and 1,4-bis(isocyanatomethyl)cyclohexane, m- and p-xylylene diisocyanate (m- and p-XDI), m- and p-tetramethyl-1,3- and -1,4-xylylene diisocyanate (m- and p-TMXDI), bis(1-isocyanato-1-methylethyl)-naphthalene, dimer and trimer fatty acid isocyanates such as 3,6-bis(9-isocyanato-nonyl)-4,5-di(1-heptenyl)cyclohexene (dimeryl diisocyanate) or dimers thereof, and any desired mixtures of the aforementioned isocyanates. Particular preference is given to HDI and IPDI and dimers thereof.

In addition, one or more polyisocyanates having a mean isocyanate functionality of 2.5 or more are used. The polyisocyanate(s) having a mean isocyanate functionality of 2.5 or more may, for example, have a mean isocyanate functionality of 2.5 to 5, preferably 2.5 to 4. The polyisocyanate(s) having a mean isocyanate functionality of 2.5 or more preferably have a mean isocyanate functionality of 3 or more.

It will be apparent that the isocyanate functionality relates to the mean isocyanate functionality since such polyisocyanates frequently contain mixtures of different species. The mean isocyanate functionality can be determined, for example, by a titrimetric isocyanate determination according to EN ISO 11909 combined with a molar mass determination by means of high-resolution mass spectroscopy, for example on an LTX Orbitrap XL from the manufacturer Thermo Scientific.

One example of a triisocyanate is α,α,α′,α′,α″,α″-hexamethyl-1,3,5-mesitylene triisocyanate. Preferred examples of polyisocyanates having a mean isocyanate functionality of 2.5 or more are oligomers, for example trimers or higher oligomers, of diisocyanates. Preference is given to isocyanurates, biurets, iminooxadiazines and allophanates of diisocyanates, especially aliphatic, cycloaliphatic, aromatic or araliphatic diisocyanates, especially of the above-described diisocyanates, particular preference being given to isocyanurates and biurets. The diisocyanate for the oligomer is in each case preferably HDI, IPDI and/or TDI, especially HDI or IPDI.

The oligomers of the diisocyanates also include modified oligomers in which the oligomers have been modified with other compounds, for example with a polyether having a hydroxyl end group, for example monoetherified ethylene glycol oligomers, e.g. O-methyl heptaethylene glycol oligomers. In this way, it is possible to obtain, for example, modified oligomers of the diisocyanates. Modified oligomers of this kind are also commercially available, for example Bayhydur®3100 which is used in the example.

Oligomers of diisocyanates which may optionally be modified are in practice frequently complex mixtures of substances having different oligomerization levels and/or chemical structures. They may also contain a small proportion of monomeric isocyanates. The oligomer may be formed, for example, from at least 2, especially at least 3, diisocyanate monomers, where the oligomer may optionally be modified. In general, the oligomer is formed, for example, from not more than 6, especially not more than 4, diisocyanate monomers. The main component is frequently the trimer, but higher oligomeric products may also be present.

Particular preference is given to biurets of HDI or IPDI, isocyanurates of HDI or IPDI, allophanates of HDI or IPDI, TDI oligomers and mixed isocyanurates of TDI and HDI. Particular preference is given to isocyanurates of HDI or IPDI. The trimeric isocyanurate of HDI or IPDI has the following general formula:

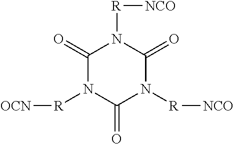

where R is (CH₂)₆ or the residue of IPDI after removal of the two isocyanate groups. In the case of IPDI isocyanurate, multiple isomers are possible, which may be in the form of a mixture. Preference is further given to the aforementioned oligomers which may be modified further, for example with one or more polyether urethane or polyether allophanate groups.

Such polyisocyanates having a mean isocyanate functionality of 2.5 or more or oligomers are commercially available. Examples of commercially available types are HDI biurets, for example Desmodur® N 100 and Desmodur® N 3200 (from Bayer), Tolonate® HDB and Tolonate® HDB-LV (from Rhodia) and Duranate® 24A-100 (from Asahi Kasei); HDI isocyanurates, for example Desmodur® N 3300, Desmodur® N 3600 and Desmodur® N 3790 BA (from Bayer), Tolonate® HDT, Tolonate® HDT-LV and Tolonate® HDT-LV2 (from Rhodia), Duranate® TPA-100 and Duranate® THA-100 (from Asahi Kasei) and Coronate® HX (from Nippon Polyurethane); HDI allophanates, for example Desmodur® VP LS 2102 (from Bayer); IPDI isocyanurates, for example Desmodur® Z 4470 (from Bayer) and Vestanat® T1890/100 (from Evonik); TDI oligomers, for example Desmodur® IL (from Bayer); mixed isocyanurates based on TDI/HDI, for example Desmodur® HL (from Bayer); and modified polymers such as Bayhydur 3100 (from Bayer), an HDI isocyanurate modified with a polyether via a urethane linkage, Bayhydur 304 (from Bayer), an HDI isocyanurate modified with a polyether via an allophanate linkage.

The molar ratio of isocyanate groups in the diisocyanate(s) to isocyanate groups in the polyisocyanate(s) having a mean isocyanate functionality of 2.5 or more that are used for preparation of the isocyanate-terminated polymer is in the range from 2:1 to 20:1, preferably from 2:1 to 10:1 or 2.5:1 to 10:1 and more preferably from 3:1 to 8:1. The molar ratio of isocyanate groups in the diisocyanate(s) to isocyanate groups in the polyisocyanate(s) having a mean isocyanate functionality of 2.5 or more surprisingly results in achievement of improved low-temperature toughness on use in epoxy resin formulations. Moreover, gel formation is avoided.

By the variation of the stoichiometry of the co-reactants and/or a staged reaction of the reactants, it is possible to vary the structure or chain length of the isocyanate-terminated polymers.

It is firstly possible, for example, in a first stage in which only a portion of the polyisocyanates is used, to obtain OH-functional polymers with chains of different length via an excess of OH groups based on NCO groups. Chain-extended polyols of this kind contain urethane groups in the chain and can be reacted further with residual polyisocyanates in a second stage, so as to form isocyanate-terminated polymers. Secondly, it is possible to obtain NCO-functional polymers with chains of different length via a deficiency of OH groups based on the NCO groups.

The chain length of the isocyanate-terminated polymers is highly dependent on the molar ratio [OH]/[NCO] of the polyols and polyisocyanates used. The closer this ratio is to 1, the longer the chains are. It will be clear to the person skilled in the art that excessively long chains would lead to polymers that are no longer usable.

For preparation of the isocyanate-terminated polymer, the proportions of polyol and polyisocyanates are preferably such that isocyanate groups are in a stoichiometric excess relative to hydroxyl groups, where the molar ratio of isocyanate groups to hydroxyl groups is, for example, greater than 1.3, preferably greater than 3:2, for example in the range from 3:1 to 3:2, preferably close to 2:1.

In the impact modifier of the invention, the isocyanate groups in the polymer terminated by isocyanate groups have been partly or fully blocked by reaction with a blocking agent, wherein preferably at least 80%, more preferably at least 96%, of the isocyanate groups in the isocyanate-terminated polymer have been blocked. In a preferred embodiment, the isocyanate groups are essentially fully blocked, i.e. to an extent of at least 99%. The blocking agent may be one or more blocking agents.

The blocking of isocyanate groups by means of appropriate blocking agents which can react with isocyanate groups in a thermally reversible manner is a standard measure in the field and the person skilled in the art will be able to conduct it without difficulty. The person skilled in the art is aware of a large number of suitable blocking agents or blocking groups, for example from the review articles by Douglas A. Wick in Progress in Organic Coatings 36 (1999), 148-172 and in Progress in Organic Coatings 41 (2001), 1-83, to which reference is hereby made.

The blocking agent is especially a proton-active compound, which is also referred to as an H-acidic compound. The hydrogen in the blocking agent that can react with an isocyanate group (acidic hydrogen) is typically bonded to an oxygen atom, a nitrogen atom, usually of a secondary amine, or a carbon atom of a CH-acidic compound. The blocking agent is therefore preferably an alcohol, a compound having at least one aromatic hydroxyl group, such as phenols and bisphenols, a secondary amine, an oxime or a CH-acidic compound. Acidic hydrogen is also referred to as active hydrogen.

It is possible here for the blocking agent to react via the acidic hydrogen with free isocyanate functionalities in a nucleophilic addition reaction according to scheme shown below. B here is the organic radical of the blocking agent after removal of the acidic hydrogen.

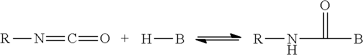

The blocking agent is preferably selected from a compound having at least one aliphatic or aromatic hydroxyl group, a compound having at least one secondary amino group, a compound having at least one oxime group, and a compound having at least one CH-acidic group, preference being given to a compound having at least one aliphatic or aromatic hydroxyl group. The blocking agent may have one or more, preferably one or two, of the groups mentioned. An aliphatic hydroxyl group is bonded to an aliphatic carbon atom. An aromatic hydroxyl group is bonded to an aromatic carbon atom, preference being given to a phenolic hydroxyl group.

Examples of suitable blocking agents are shown below:

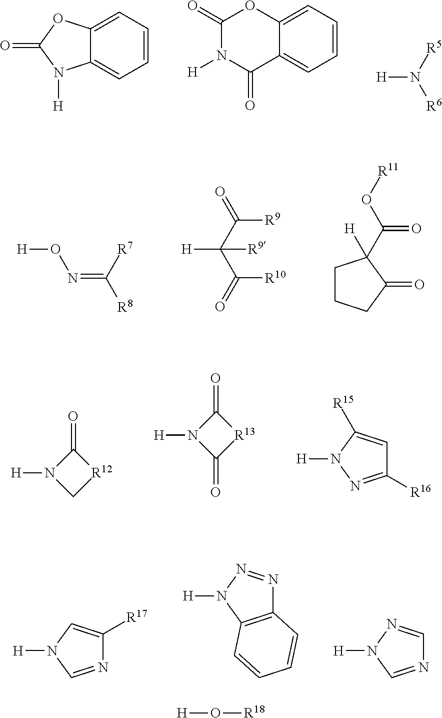

In these formulae, R⁵, R⁶, R⁷ and R⁸ are each independently an alkyl or cycloalkyl or aryl or aralkyl or arylalkyl group, or R⁵ together with R⁶ or R⁷ together with R⁸ form part of a 4- to 7-membered ring which is optionally substituted.

In addition, R⁹, R^{9′} and R¹⁰ are each independently an alkyl or aralkyl or aryl or arylalkyl group or an alkyloxy or aryloxy or aralkyloxy group. R¹¹ is an alkyl group.

In addition, R¹² and R¹³ are each independently an alkylene group which has 2 to 5 carbon atoms and optionally has double bonds and/or is substituted, or a phenylene group or a hydrogenated phenylene group.

R¹⁵, R¹⁶ and R¹⁷ are each independently H or an alkyl group or an aryl group or an aralkyl group. R¹⁸ is a substituted or unsubstituted aralkyl group or preferably a mono- or polycyclic substituted or unsubstituted aromatic group, especially substituted or unsubstituted phenyl group, optionally having one or more aromatic hydroxyl groups.

The blocking agent is preferably an alcohol, especially an aralkyl alcohol, for example benzyl alcohol, and especially a phenol or a bisphenol. The phenols and bisphenols may have one or more substituents. Suitable substituents are, for example, alkyl, e.g. C₁₋₂₀-alkyl, alkenyl, e.g. C₂₋₂₀-alkenyl, alkoxy, e.g. C₁₋₂₀-alkoxy, preferably C₁₋₄-alkoxy, or aryl, e.g. phenyl.

Examples of phenols and bisphenols suitable as blocking agents are especially phenol, cardanol (3-pentadecenylphenol (from cashewnut shell oil)), nonylphenol, m/p-methoxyphenols, phenols that have been reacted with styrene or dicyclopentadiene, bisphenol A and bisphenol F.

The invention also relates to a process for preparing an impact modifier according to the invention, comprising
A) the reaction of
   a) one or more polyols comprising polytetramethylene ether glycol in a proportion of at least 95% by weight, based on the total weight of the polyols, and
   b) two or more polyisocyanates including at least one diisocyanate and at least one polyisocyanate having a mean isocyanate functionality of 2.5 or more,
optionally in the presence of a catalyst, where the molar ratio of isocyanate groups in the diisocyanate(s) to isocyanate groups in the polyisocyanate(s) having a mean isocyanate functionality of 2.5 or more is in the range of 2:1 to 20:1, preferably 2.5:1 to 10:1, to form an isocyanate-terminated polymer, and
B) reacting the isocyanate-terminated polymer with a blocking agent optionally in the presence of a catalyst, in order to partly or fully block the isocyanate groups of the isocyanate-terminated polymer.

All the aforementioned details relating to the impact modifier of the invention apply correspondingly to the process of the invention.

The reaction of polyols, here PTMEG and optionally further polyols in small amounts, and polyisocyanates and the conditions suitable for the purpose are familiar to the person skilled in the art. For the preparation of the isocyanate-terminated polymer, a mixture of PTMEG and optionally further polyols in a proportion of less than 5% by weight, based on the total weight of the polyols, and the polyisocyanates are reacted. The starting components can optionally be also added stepwise; for example, it is possible, as already elucidated above, to react the polyol(s) with a portion of polyisocyanate in order first to obtain a hydroxyl-terminated polymer, and then to add residual polyisocyanate in order to obtain the isocyanate-terminated polymer.

For the reaction in step A), it is optionally possible to add a catalyst. Examples of suitable catalysts are, for example, organic tin compounds such as dibutyltin dilaurate (DBTL), or else organic bismuth compounds such as Bi(III) neodecanoate.

It is optionally also possible to add stabilizers, for example for PTMEG, e.g. butylhydroxytoluene (BHT).

The reaction in step A) is appropriately conducted at elevated temperature, for example at a temperature of at least 60° C., preferably at least 80° C., especially at a temperature in the range from 80° C. to 100° C., preferably around 90° C. The duration naturally depends greatly on the reaction conditions chosen and may, for example, be in the range from 15 min to 6 h. The progress or ending of the reaction can be monitored directly with reference to the analysis of isocyanate content in the reaction mixture.

The blocking of the isocyanate groups with the blocking agent and the conditions suitable for the purpose are likewise familiar to the person skilled in the art.

For the reaction in step B), it is likewise optionally possible to add a catalyst. Examples of suitable catalysts are, for example, organic tin compounds such as dibutyltin dilaurate (DBTL), or else organic bismuth compounds such as Bi(III) neodecanoate. The reaction in step B) is appropriately conducted at elevated temperature, for example at a temperature of at least 90° C., preferably at least 100° C., especially at a temperature in the range from 100 to 135° C., preferably around 110° C. The duration naturally depends greatly on the reaction conditions chosen and may, for example, be in the range from 15 min to 24 h. The progress or ending of the reaction can be monitored directly with reference to the analysis of isocyanate content in the reaction mixture.

The molar ratio of isocyanate groups in the isocyanate-terminated polymer to the H-acidic groups, especially hydroxyl groups, in the blocking agent can be chosen as required, but is, for example, in the range from 1:1 to 2:3, preferably from 1:1.15 to 1:1.25. In this way, it is possible to achieve essentially complete blocking.

The products obtained in step A) and step B) can be used or used further as they are, meaning that workup is generally not required. The formation of the isocyanate-terminated polymer and the blocking of isocyanate groups can, for example, advantageously be conducted as a one-pot reaction.

The impact modifier of the invention is especially suitable for use in a one-component (1K) or two-component (2K) epoxy resin composition, preferably a 1K epoxy resin composition, for increasing the impact resistance of the cured epoxy resin matrix. The 2K or 1K epoxy resin composition may be in the form of a liquid, paste or solid and/or cure at low or high temperature.

The epoxy resin composition is preferably a 1K or 2K epoxy resin adhesive, especially a structural or crash-resistant adhesive, for example for OEM products, EP/PU hybrids, structural foams composed of epoxy resin systems (such as Sika Reinforcer®) or repair applications, particular preference being given to a 1K epoxy resin adhesive.

The one-component or two-component epoxy resin composition of the invention comprises at least one epoxy resin, at least one hardener for epoxy resins, and the impact modifier according to the invention. The impact modifier of the invention has already been described above. The proportion of the impact modifier of the invention in the epoxy resin composition may vary within wide ranges, but is, for example, within a range from 5% to 60% by weight, preferably from 10% to 25% by weight, based on the total weight of the epoxy resin composition.

The epoxy resin present in the epoxy resin composition may be any customary epoxy resin used in this field. Epoxy resins are obtained, for example, from the reaction of an epoxy compound, for example epichlorohydrin, with a polyfunctional aliphatic or aromatic alcohol, i.e. a diol, triol or polyol. It is possible to use one or more epoxy resins. The epoxy resin is preferably a liquid epoxy resin and/or a solid epoxy resin.

Liquid epoxy resins or solid epoxy resins are preferably diglycidyl ethers, for example of the formula (I)

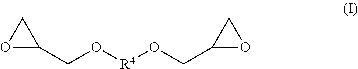

in which R⁴ is a divalent aliphatic or monocyclic aromatic or bicyclic aromatic radical.

Examples of diglycidyl ethers are especially
diglycidyl ethers of difunctional saturated or unsaturated, branched or unbranched, cyclic or open-chain C₂-C₃₀ alcohols, for example ethylene glycol glycidyl ether, butanediol glycidyl ether, hexanediol diglycidyl ether, octanediol glycidyl ether, cyclohexanedimethanol diglycidyl ether, neopentyl glycol diglycidyl ether;
diglycidyl ethers of difunctional low to high molecular weight polyether polyols, for example polyethylene glycol diglycidyl ether, polypropylene glycol diglycidyl ether;
diglycidyl ethers of difunctional diphenols and optionally triphenols, which is understood to mean not just pure phenols but optionally also substituted phenols.

The manner of substitution may be very varied. More particularly, this is understood to mean substitution directly on the aromatic ring to which the phenolic OH group is bonded. Phenols are also understood to mean not just monocyclic aromatics but also polycyclic or fused aromatics and heteroaromatics having the phenolic OH group directly on the aromatic or heteroaromatic system. Examples of suitable bisphenols and optionally triphenols include 1,4-dihydroxybenzene, 1,3-dihydroxybenzene, 1,2-dihydroxybenzene, 1,3-dihydroxytoluene, 3,5-dihydroxybenzoate, 2,2-bis(4-hydroxy-phenyl)propane (=bisphenol A), bis(4-hydroxyphenyl)methane (=bisphenol F), bis(4-hydroxyphenyl) sulfone (=bisphenol S), naphthoresorcinol, dihydroxynaphthalene, dihydroxyanthraquinone, dihydroxybiphenyl, 3,3-bis(p-hydroxyphenyl)phthalide, 5,5-bis(4-hydroxyphenyl)hexahydro-4,7-methanoindane, phenolphthalein, fluorescein, 4,4′-[bis(hydroxyphenyl)-1,3-phenylenebis-(1-methylethylidene)] (=bisphenol M), 4,4′-[bis(hydroxyphenyl)-1,4-phenylenebis-(1-methylethylidene)] (=bisphenol P), 2,2′-diallyl bisphenol A, diphenols and dicresols prepared by reaction of phenols or cresols with diisopropylidenebenzene, phloroglucinol, gallic esters, phenol or cresol novolaks with —OH functionality of 2.0 to 3.5, and all isomers of the aforementioned compounds.

Particularly preferred epoxy resins are liquid epoxy resins of the formula (A-I) and solid epoxy resins of the formula (A-II).

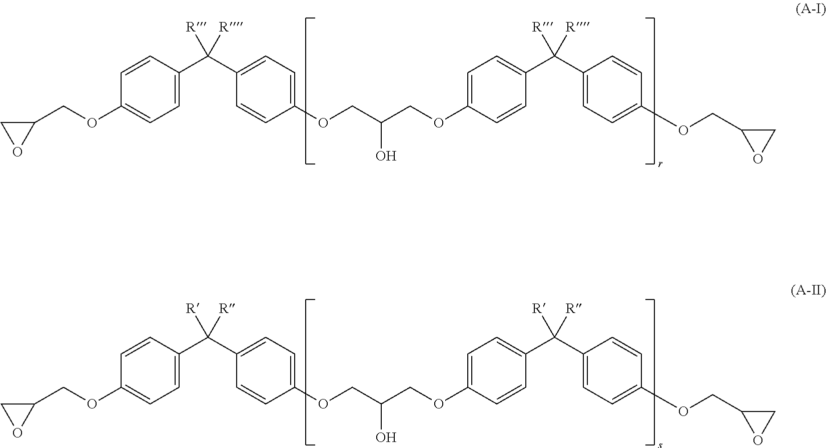

In these formulae, the substituents R′, R″, R′″ and R″″ are independently either H or CH₃. In addition, the index r has a value of 0 to 1. Preferably, r has a value of less than 0.2. In addition, the index s has a value of >1, especially >1.5, especially from 2 to 12.

Compounds of the formula (A-II) having an index s of greater than 1 to 1.5 are referred to by the person skilled in the art as semisolid epoxy resins. For this present invention, they are likewise considered to be solid resins. However, preference is given to solid epoxy resins in the narrower sense, i.e. where the index s has a value of >1.5.

Solid epoxy resins of this kind are commercially available, for example, from Dow or Huntsman or Hexion. Commercially available liquid epoxy resins of the formula (A-I) are obtainable, for example, as Araldite® GY 250, Araldite® PY 304, Araldite® GY 282 (Huntsman, or Hexion) or D.E.R.™ 331 or D.E.R.™ 330 (Dow) or D.E.R.™ 332 (Dow) or Epikote 828 (Hexion).

Preferably, the diglycidyl ether of the formula (I) is a liquid epoxy resin, especially a liquid epoxy resin of the formula (A-I), especially a diglycidyl ether of bisphenol A (BADGE), of bisphenol F and bisphenol A/F. In addition, epoxidized novolaks are also preferred epoxy resins.

The epoxy resin composition further comprises a hardener for the epoxy resin. In one embodiment, especially for the one-component epoxy resin composition, the hardener for epoxy resins is one which is activated by elevated temperature. In this embodiment, the composition is a heat-curing epoxy resin composition. “Elevated temperature” is generally understood here to mean, for example, a temperature exceeding 100° C., generally exceeding 110° C. or more preferably exceeding 120° C., especially between 110° C. and 200° C. or 120° C. to 200° C. Such a hardener for epoxy resins is preferably a hardener selected from the group consisting of dicyandiamide, guanamines, guanidines, aminoguanidines and derivatives thereof. Also possible are accelerating hardeners, such as substituted ureas, for example 3-chloro-4-methylphenylurea (chlortoluron), or phenyldimethylureas, especially p-chlorophenyl-N,N-dimethylurea (monuron), 3-phenyl-1,1-dimethylurea (fenuron) or 3,4-dichlorophenyl-N, N-dimethylurea (diuron), but also aliphatically substituted ureas. In addition, it is also possible to use compounds from the class of the imidazoles, such as 2-isopropylimidazole or 2-hydroxy-N-(2-(2-(2-hydroxyphenyl)-4,5-dihydroimidazol-1-yl)ethyl)benzamide and amine complexes.

Preferably, the heat-activatable hardener is a hardener selected from the group consisting of dicyandiamide, guanamines, guanidines, am inoguanidines and derivatives thereof; substituted ureas, especially 3-chloro-4-methylphenylurea (chlortoluron), or phenyldimethylureas, especially p-chlorophenyl-N,N-dimethylurea (monuron), 3-phenyl-1,1-dimethylurea (fenuron), 3,4-dichlorophenyl-N, N-dimethylurea (diuron) or else aliphatically substituted ureas, and also imidazoles and amine complexes. A particularly preferred hardener is dicyandiamide.

Advantageously, the total proportion of the hardener for epoxy resins which is activated by elevated temperature is 0.5% to 10% by weight, preferably 1% to 8% by weight, based on the weight of the overall composition.

The hardener used for epoxy resin compositions may, in an alternative embodiment, especially comprise, for example, polyamines, polymercaptans, polyamidoamines, amino-functional polyamine/polyepoxide adducts, as are particularly well-known to the person skilled in the art as hardeners. These hardeners are especially suitable for a two-component epoxy resin composition consisting of two components, i.e. a first component and a second component. The first component comprises, for example, at least the impact modifier according to the invention and at least one epoxy resin, especially a liquid epoxy resin and/or solid epoxy resin. The second component comprises at least one hardener for epoxy resins. The first component and the second component are each stored in an individual container. Only at the time of use are the two components mixed with one another and the reactive constituents react with one another and hence lead to crosslinking of the composition. Two-component epoxy resin compositions of this kind are already curable at low temperatures, typically between 0° C. and 100° C., especially at room temperature. In this embodiment, curing is effected by an addition reaction between the hardener and the compounds having epoxy groups that are present in the composition. It is thus particularly advantageous in this embodiment when the amount of the hardener in the overall composition is such that the epoxy-reactive groups are in a stoichiometric ratio relative to the epoxy groups.

The epoxy resin composition may optionally also comprise at least one additional optional impact modifier different than the impact modifiers of the invention that have already been described. The additional impact modifiers may be solid or liquid.

In one embodiment, this additional impact modifier is a liquid rubber which is a carboxyl- or epoxy-terminated acrylonitrile/butadiene copolymer or a derivative thereof. Liquid rubbers of this kind are commercially available, for example, under Hypro® (formerly Hycar®) CTBN and CTBNX and ETBN name from Emerald Performance Materials LLC. Suitable derivatives are especially elastomer-modified pre-polymers having epoxy groups, as sold commercially under the Polydis® product line, preferably from the Polydis® 36. product line, from Struktol® (Schill+Seilacher Gruppe, Germany) or under the Albipox® product line (Evonik Hanse GmbH, Germany). In a further embodiment, the impact modifier is a liquid polyacrylate rubber which is fully miscible with liquid epoxy resins and only separates on curing of the epoxy resin matrix to give microdroplets. Liquid polyacrylate rubbers of this kind are available, for example, under the 20208-XPA name from Rohm and Haas.

It will be clear to the person skilled in the art that it is of course also possible to use mixtures of liquid rubbers, especially mixtures of carboxyl- or epoxy-terminated acrylonitrile/butadiene copolymers or derivatives thereof with epoxy-terminated polyurethane prepolymers.

In a further embodiment, the additional impact modifier may be a solid impact modifier which is an organic ion-exchanged laminar mineral. The ion-exchanged laminar mineral may either be a cation-exchanged or anion-exchanged laminar mineral. It is also possible that the composition simultaneously contains a cation-exchanged laminar mineral and an anion-exchanged laminar mineral.

The cation-exchanged laminar mineral is obtained here from a laminar mineral in which at least some of the cations have been exchanged for organic cations. Examples of cation-exchanged laminar minerals of this kind are especially those that are mentioned in U.S. Pat. No. 5,707,439 or in U.S. Pat. No. 6,197,849. Also described therein is the process for producing these cation-exchanged laminar minerals. A preferred laminar mineral is a sheet silicate. The laminar mineral is especially preferably a phyllosilicate as described in U.S. Pat. No. 6,197,849, column 2 line 38 to column 3 line 5, especially a bentonite. Particularly suitable laminar minerals have been found to be those such as kaolinite or a montmorillonite or a hectorite or an illite.

At least some of the cations in the laminar mineral have been replaced by organic cations. Examples of such cations are n-octylammonium, trimethyldodecyl-ammonium, dimethyldodecylammonium or bis(hydroxyethyl)octadecylammonium or similar derivatives of amines which can be obtained from natural fats and oils; or guanidinium cations or amidinium cations; or cations of the N-substituted derivatives of pyrrolidine, piperidine, piperazine, morpholine, thiomorpholine; or cations of 1,4-diazabicyclo[2.2.2]octane (DABCO) and 1-azabicyclo[2.2.2]octane; or cations of N-substituted derivatives of pyridine, pyrrole, imidazole, oxazole, pyrimidine, quinoline, isoquinoline, pyrazine, indole, benzimidazole, benzoxazole, thiazole, phenazine and 2,2′-bipyridine. Also suitable are cyclic amidinium cations, especially those as disclosed in U.S. Pat. No. 6,197,849 in column 3 line 6 to column 4 line 67.

Preferred cation-exchanged laminar minerals are known to the person skilled in the art under the Organoclay or Nanoclay name and are commercially available, for example, under the group names Tixogel® or Nanofil® (SUdchemie), Cloisite® (Southern Clay Products) or Nanomer® (Nanocor Inc.) or Garmite® (Rockwood).

The anion-exchanged laminar mineral is obtained from a laminar mineral in which at least some of the anions have been exchanged for organic anions. One example of an anion-exchanged laminar mineral is a hydrotalcite in which at least some of the carbonate anions in the interlayers have been exchanged for organic anions.

In a further embodiment, the additional impact modifier is a solid impact modifier which is a block copolymer. The block copolymer is obtained from an anionic or controlled free-radical polymerization of methacrylic ester with at least one further monomer having an olefinic double bond. Preferred monomers having an olefinic double bond are especially those in which the double bond is directly conjugated to a heteroatom or to at least one further double bond. Especially suitable are monomers selected from the group comprising styrene, butadiene, acrylonitrile and vinyl acetate. Preference is given to acrylate-styrene-acrylic acid (ASA) copolymers obtainable, for example, under the GELOY® 1020 name from GE Plastics. Particularly preferred block copolymers are block copolymers formed from methyl methacrylate, styrene and butadiene. Block copolymers of this kind are obtainable, for example, as triblock copolymers under the SBM group name from Arkema.

In a further embodiment, the additional impact modifier is a core-shell polymer. Core-shell polymers consist of an elastic core polymer and a rigid shell polymer. Especially suitable core-shell polymers consist of a core composed of elastic acrylate or butadiene polymer, encased by a rigid shell of a rigid thermoplastic polymer. This core-shell structure forms either spontaneously through separation of a block copolymer or is defined by the conduct of the polymerization as a latex or suspension polymerization with subsequent grafting. Preferred core-shell polymers are what are called MBS polymers, which are commercially available under the Clearstrength® trade name from Arkema, Paraloid® from Dow (formerly Rohm and Haas) or F351® from Zeon.

Particular preference is given to core-shell polymer particles that are already in the form of a dried polymer latex. Examples of these are GENIOPERL® M23A from Wacker with a polysiloxane core and acrylate shell, radiation-crosslinked rubber particles from the NEP series, manufactured by Eliokem, or Nanoprene® from Lanxess or Paraloid® EXL from Dow. Further comparable examples of core-shell polymers are supplied under the Albidur® name by Evonik Hanse GmbH, Germany. Likewise suitable are nanoscale silicates in epoxide matrix, as supplied under the Nanopox trade name by Evonik Hanse GmbH, Germany.

In a further embodiment, the additional impact modifier is a reaction product of a carboxylated solid nitrile rubber with excess epoxy resin.

It has been found that one or more additional impact modifiers are advantageously present in the composition. It has been found to be particularly advantageous for a further impact modifier of this kind to be an impact modifier which has epoxy group ends and is of the formula (II).

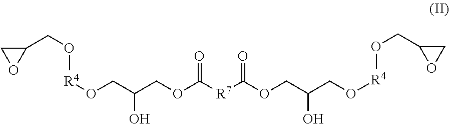

In this formula, R⁷ is a divalent radical of a butadiene/acrylonitrile copolymer (CTBN) terminated by carboxyl groups after removal of the terminal carboxyl groups. The R⁴ radical is as defined and described above for formula (I). More particularly, R⁷ is a radical which is obtained by formal removal of the carboxyl groups from a butadiene/acrylonitrile copolymer CTBN terminated by carboxyl groups which is sold commercially under the Hypro® CTBN name by Noveon. R⁷ is preferably a divalent radical of the formula (II′).

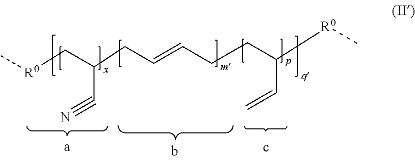

R⁰ here is a linear or branched alkylene radical having 1 to 6 carbon atoms, especially having 5 carbon atoms, which is optionally substituted by unsaturated groups. In an embodiment that should be given particular mention, the substituent R⁰ is a radical of the formula (II-a).

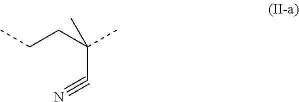

In addition, the index q′ is a value from 40 to 100, especially from 50 to 90. The designations b and c represent the structural elements which originate from butadiene and a represents the structural element which originates from acrylonitrile. The indices x, m′, and p′ in turn are values that describe the ratio of the structural elements a, b and c to one another. The index x represents values from 0.05 to 0.3, the index m′ represents values of 0.5-0.8, the index p represents values of 0.1-0.2, with the proviso that the sum total of x, m′ and p is 1.

It will be clear to the person skilled in the art that the structure shown in formula (II′) should be regarded as a simplified illustration. Thus, the units a, b and c may each be arranged randomly, alternatively or in blocks with respect to one another. More particularly, formula (II′) is thus not necessarily a triblock copolymer.

The impact modifier of the formula (II) is prepared by the reaction of a butadiene/acrylonitrile copolymer (CTBN) terminated by carboxyl groups, especially of the formula (III), where the substituents are as defined in formula (II), with an above-elucidated diglycidyl ether of the formula (I) in a stoichiometric excess of the diglycidyl ether, meaning that the ratio of the glycidyl ether groups to the COOH groups is not less than 2.

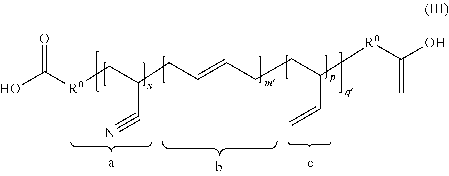

The proportion of the above-described additional impact modifier(s) other than the epoxy-terminated impact modifier in the liquid rubber of the invention is, for example, 0% to 45% by weight, preferably 1% to 45% by weight, especially 3% to 35% by weight, based on the weight of the overall composition.

The epoxy resin composition may of course comprise other constituents. More particularly, these are fillers, reactive diluents, such as reactive diluents bearing epoxy groups, catalysts, stabilizers, especially heat and/or light stabilizers, thixotropic agents, plasticizers, solvents, mineral or organic fillers, blowing agents, dyes and pigments, corrosion stabilizers, surfactants, defoamers and adhesion promoters. In respect of these additives, it is possible to use all those known in the art in the customary amounts.

The fillers are preferably, for example, mica, talc, kaolin, wollastonite, feldspar, syenite, chlorite, bentonite, montmorillonite, calcium carbonate (precipitated or ground), dolomite, quartz, silicas (fumed or precipitated), cristobalite, calcium oxide, aluminum hydroxide, magnesium oxide, hollow ceramic beads, hollow glass beads, hollow organic beads, glass beads, color pigments. Fillers mean both the organically coated forms and the uncoated commercially available forms that are known to the person skilled in the art.

Advantageously, the total content of the overall filler is 3% to 50% by weight, preferably 5% to 35% by weight, especially 5% to 25% by weight, based on the weight of the overall composition.

The reactive diluents are especially:
glycidyl ethers of monofunctional saturated or unsaturated, branched or unbranched, cyclic or open-chain C₄-C₃₀ alcohols, especially selected from the group consisting of butanol glycidyl ether, hexanol glycidyl ether, 2-ethylhexanol glycidyl ether, allyl glycidyl ether, tetrahydrofurfuryl and furfuryl glycidyl ether, trimethoxysilyl glycidyl ether;
glycidyl ethers of difunctional saturated or unsaturated, branched or unbranched, cyclic or open-chain C₂-C₃₀ alcohols, especially selected from the group consisting of ethylene glycol glycidyl ether, butanediol glycidyl ether, hexanediol glycidyl ether, octanediol glycidyl ether, cyclohexanedimethanol diglycidyl ether and neopentyl glycol diglycidyl ether;
glycidyl ethers of tri- or polyfunctional, saturated or unsaturated, branched or unbranched, cyclic or open-chain alcohols, such as epoxidized castor oil, epoxidized trimethylolpropane, epoxidized pentaerythritol or polyglycidyl ethers of aliphatic polyols such as sorbitol, glycerol or trimethylolpropane;
glycidyl ethers of phenol compounds and aniline compounds, especially selected from the group consisting of phenyl glycidyl ether, cresyl glycidyl ether, p-tert-butylphenyl glycidyl ether, nonylphenol glycidyl ether, 3-n-pentadecenyl glycidyl ether (from cashewnut shell oil), N,N-diglycidylaniline and triglycidyl of p-aminophenol;
epoxidized amines such as N,N-diglycidylcyclohexylamine;
epoxidized mono- or dicarboxylic acids, especially selected from the group consisting of glycidyl neodecanoate, glycidyl methacrylate, glycidyl benzoate, diglycidyl phthalate, tetrahydrophthalate and hexahydrophthalate, and diglycidyl esters of dimeric fatty acids, and also glycidyl terephthalate and trimellitate;
epoxidized di- or trifunctional, low to high molecular weight polyether polyols, especially polyethylene glycol diglycidyl ether or polypropylene glycol diglycidyl ether.

Particular preference is given to hexanediol diglycidyl ether, cresyl glycidyl ether, p-tert-butylphenyl glycidyl ether, polypropylene glycol diglycidyl ether and polyethylene glycol diglycidyl ether.

Advantageously, the total proportion of the reactive diluent is 0.1% to 20% by weight, preferably 1% to 8% by weight, based on the weight of the overall epoxy resin composition.

Suitable plasticizers are, for example, phenol alkylsulfonates or N-butylbenzene-sulfonamide, which are respectively available as Mesamoll® and Dellatol BBS from Bayer. Examples of suitable stabilizers include optionally substituted phenols such as butylhydroxytoluene (BHT) or Wingstay® T (Elikem), sterically hindered amines or N-oxyl compounds such as TEMPO (Evonik).

In a particular embodiment, the epoxy resin composition further comprises at least one physical or chemical blowing agent, especially in an amount of 0.1% to 3% by weight, based on the weight of the composition. Preferred blowing agents are chemical blowing agents which release a gas when heated, especially to a temperature of 100 to 200° C. The blowing agents may be exothermic blowing agents, for example azo compounds, hydrazine derivatives, semicarbazides or tetrazoles. Preference is given to azodicarbonamide and oxybis(benzenesulfonyl hydrazide), which release energy on decomposition. Also additionally suitable are endothermic blowing agents, for example sodium bicarbonate/citric acid mixtures. Chemical blowing agents of this kind are available, for example, under the Celogen® name from Chemtura. Likewise suitable are physical blowing agents that are sold under the Expancel® trade name by Akzo Nobel. Expancel® and Celogen® are particularly preferred.

Examples of compositions and proportions for a preferred high-temperature-curing 1K epoxy resin adhesive comprising the impact modifier of the invention are given hereinafter. The percentages are based on weight.
A) 20%-60% epoxy resins (e.g. liquid resin, solid resin, epoxidized novolaks etc.)
B) 0%-15% reactive diluent (e.g. hexanediol diglycidyl ether)
C) 10%-60% of the impact modifier of the invention, preferably fully blocked,
D) 0%-10% of a diisocyanate,
E) 0%-40% CTBN derivative (e.g. CTBN derivatives of the formula (II) such as CTBN epoxy resin adducts, e.g. Polydis Struktol from Schill+Seilacher)
F) 0%-40% of a core-shell toughener such as Kaneka MX-125 or other rubber particles as unreactive flexibilizers
G) 0%-25% HAT paste (adduct of MDI and monobutylamine, cf. EP 1152019)
H) 1%-10%, preferably 2%-7%, hardener and catalysts
I) 0%-40% organic or mineral fillers

The one-component epoxy resin composition, especially an adhesive, especially cures at high temperature. The curing is effected by heating the composition to a temperature above the heat activation of the thermally activatable hardener. This hardening temperature is preferably a temperature in the range from 100 to 220° C., preferably 120 to 200° C. In the case of a two-component epoxy resin composition, the mixing of the first component and the second component is followed by a reaction which leads to curing of the composition.

The epoxy resin composition of the invention is especially suitable for use as an adhesive, especially as a one-component adhesive, and is preferably used for bonding of at least two substrates. The adhesives are especially suitable for automobiles or installable or incorporatable modules for motor vehicles. In addition, the compositions of the invention are also suitable for other fields of use. Particular mention should be made of related uses in the construction of modes of transport such as ships, trucks, buses or rail vehicles, in the construction of consumer goods, for example washing machines, but also in the construction sector, for example as reinforcing structural adhesives. As well as adhesives, it is also possible to create sealing compounds or coatings with a composition of the invention.

The materials to be bonded or coated are preferably metals and plastics such as ABS, polyamide, polyphenylene ethers, composite materials such as SMC, unsaturated GFR polyester, epoxide or acrylate composite materials. Preference is given to the application in which at least one material is a metal. A particularly preferred use is considered to be the bonding of identical or different metals, especially in bodywork construction in the automobile industry. The preferred metals are in particular steel, especially electrolytically galvanized, hot-dip galvanized, and oiled steel, Bonazinc-coated steel, and subsequently phosphated steel, and also aluminum, especially in the variants that typically occur in automaking.

The use of the impact modifier of the invention in 1K or 2K epoxy resin compositions, especially epoxy resin adhesives, as impact modifier achieves an increase in toughness compared to the same epoxy resin composition except without the impact modifier of the invention. Astonishingly, an improved low-temperature impact resistance in particular is achieved, for example at a temperature of −10° C. or less, especially at −30° C. for example.

### EXAMPLES

Adduced hereinafter are some examples which further illustrate the invention, but are not intended to restrict the scope of the invention in any way. Unless stated otherwise, all proportions and percentages are based on weight.

For determination of the parameters specified hereinafter, the test methods which follow were used.

### Determination of Isocyanate Content

The isocyanate content was determined in % by weight by means of back-titration with di-n-butyl amine used in excess and 0.1 M hydrochloric acid. All determinations were conducted in a semi-manual manner in a Mettler-Toledo DL50 Graphix titrator with automatic potentiometric endpoint determination. For this purpose, in each case, 600-800 mg of the sample to be determined were dissolved while heating in a mixture of 10 ml of isopropanol and 40 ml of xylene, and then reacted with a solution of dibutylamine in xylene. Excess di-n-butylamine was titrated with 0.1 M hydrochloric acid and isocyanate content was calculated therefrom.

### Determination of Viscosity

Viscosity measurements were effected on an MCR 101 rheometer from the manufacturer Anton Paar by a rotation method using a plate-plate geometry with the following parameters: rotation at 50 s⁻¹, 0.2 mm gap, plate-plate separation 25 mm.

For the preparation of impact modifiers SM 1 to SM6, the following starting materials were used:

| Starting materials | Description | Supplier |
|---|---|---|
| IPDI | Isophorone diisocyanate | Evonik |
| HDI | Hexamethylene diisocyanate | Sigma-Aldrich |
| BHT (Ionol ® CP) | Stabilizer, butylhydroxytoluene | Evonik |
| Vestanat ®HB | HDI biuret, NCO functionality | Evonik |
| 2640/100 | 3-4 | |
| Bayhydur ®304 | HDI isocyanurate, modified, | Bayer |
| | NCO functionality about 3.8 | |
| Bayhydur ®3100 | HDI isocyanurate, modified, | Bayer |
| | NCO functionality about 3.2 | |
| Desmodur ®N3600 | HDI isocyanurate, NCO | Bayer |
| | functionality about 3.2 | |
| Terathane ®2000 | Polytetramethylene ether | Invista B.V. |
| | glycol, polymerization level | |
| | about 27 (average) | |
| Dibutyltin dilaurate | Catalyst | Thorson |
| (DBTL) | | |
| Cardolite ®NC-700 | 3-Pentadecenylphenol (from | Cardolite |
| | cashewnut shell oil) | Corporation |

### Comparative Example 1: Impact Modifier 1 (SM1)

300 g of Terathane 2000 and 0.3 g BHT as stabilizer were dewatered with minimal stirring in a planetary mixer under reduced pressure at 90° C. for 1 h. Subsequently, 67.23 g of IPDI and 0.047 g of DBTL were added. The reaction was conducted at 90° C. with moderately vigorous stirring under reduced pressure for 2 h in order to obtain an isocyanate-terminated polymer: measured free NCO content: 3.32% (theoretical NCO content: 3.46%).

104.46 g of Cardolite NC-700 were added to the NCO-terminated polymer obtained. 0.094 g of DBTL was added to the mixture, which was converted with relatively vigorous stirring at 110° C. under reduced pressure for 5 hours in order to obtain a blocked polymer. To make the blocking level complete, the polymer was then stored in a closed container at 70° C. in a heating cabinet overnight. NCO content (1 d): 0.19%

Viscosity (1 d): 167 Pa*s at 25° C., 36 Pa*s at 50° C.

### Comparative Example 2: Impact Modifier 2 (SM2)

300 g of Terathane 2000 and 0.3 g BHT as stabilizer were dewatered with minimal stirring under reduced pressure at 90° C. for 1 h. Subsequently, 50.87 g of HDI and 0.045 g of DBTL were added. The reaction was conducted at 90° C. with moderately vigorous stirring under reduced pressure for 2 h in order to obtain an isocyanate-terminated polymer: measured free NCO content: 3.28% (theoretical NCO content: 3.62%).

98.69 g of Cardolite NC-700 were added to the NCO-terminated polymer obtained. 0.090 g of DBTL was added to the mixture, which was converted with relatively vigorous stirring at 110° C. under reduced pressure for 3 hours in order to obtain a blocked polymer: measured free NCO content (3 h): 0.01%.

Viscosity (1 d): 389 Pa*s at 25° C., 53 Pa*s at 50° C.

### Example 1: Impact Modifier 3 (SM3)

350 g of Terathane 2000 and 0.3 g BHT as stabilizer were dewatered with minimal stirring under reduced pressure at 90° C. for 1 h. Subsequently, 58.83 g of IPDI, 16.84 g of Vestanat 2640HB/100 and 0.052 g of DBTL were added. The reaction was conducted at 90° C. with moderately vigorous stirring under reduced pressure for 2 h in order to obtain an isocyanate-terminated polymer: measured free NCO content: 2.46% (theoretical NCO content: 2.62%).

89.69 g of Cardolite NC-700 were added to the NCO-terminated polymer obtained. 0.103 g of DBTL was added to the mixture, which was converted with relatively vigorous stirring at 110° C. under reduced pressure for 5 hours in order to obtain a blocked polymer. To make the blocking level complete, the polymer was then stored in a closed container at 70° C. in a heating cabinet overnight. NCO content (1 d) 0.16%

Viscosity (1 d): 939 Pa*s at 25° C., 278 Pa*s at 50° C.

### Example 2: Impact Modifier 4 (SM4)

350 g of Terathane 2000 and 0.3 g BHT as stabilizer were dewatered with minimal stirring under reduced pressure at 90° C. for 1 h. Subsequently, 58.83 g of IPDI, 20.29 g of Bayhydur 304 and 0.052 g of DBTL were added. The reaction was conducted at 90° C. with moderately vigorous stirring under reduced pressure for 2 h in order to obtain an isocyanate-terminated polymer: measured free NCO content: 2.44% (theoretical NCO content: 2.59%).

89.79 g of Cardolite NC-700 were added to the NCO-terminated polymer obtained. 0.104 g of DBTL was added to the mixture, which was converted with relatively vigorous stirring at 110° C. under reduced pressure for 5 hours in order to obtain a blocked polymer. To make the blocking level complete, the polymer was then stored in a closed container at 70° C. in a heating cabinet overnight. NCO content (1 d after preparation): 0.14%

Viscosity (1 d): 978 Pa*s at 25° C., 300 Pa*s at 50° C.

### Example 3: Impact Modifier 5 (SM5)

300 g of Terathane 2000 and 0.3 g BHT as stabilizer were dewatered with minimal stirring under reduced pressure at 90° C. for 1 h. Subsequently, 50.51 g of IPDI, 36.51 g of Bayhydur 3100 and 0.049 g of DBTL were added. The reaction was conducted at 90° C. with moderately vigorous stirring under reduced pressure for 2 h in order to obtain an isocyanate-terminated polymer: measured free NCO content: 2.97% (theoretical NCO content: 3.29%).

98.48 g of Cardolite NC-700 were added to the NCO-terminated polymer obtained. 0.097 g of DBTL was added to the mixture, which was converted with relatively vigorous stirring at 110° C. under reduced pressure for 3 hours in order to obtain a blocked polymer. NCO content (3 h): 0.01% Viscosity (1 d): 1160 Pa*s at 25° C., 343 Pa*s at 50° C.

### Example 4: Impact Modifier 6 (SM6)

300 g of Terathane 2000 and 0.3 g BHT as stabilizer were dewatered with minimal stirring under reduced pressure at 90° C. for 1 h. Subsequently, 50.51 g of IPDI, 27.67 g of Desmodur N3600 and 0.048 g of DBTL were added. The reaction was conducted at 90° C. with moderately vigorous stirring under reduced pressure for 2 h in order to obtain an isocyanate-terminated polymer: measured free NCO content: 3.07% (theoretical NCO content: 3.36%).

99.52 g of Cardolite NC-700 were added to the NCO-terminated polymer obtained. 0.096 g of DBTL was added to the mixture, which was converted with relatively vigorous stirring at 110° C. under reduced pressure for 5 hours in order to obtain a blocked polymer. To make the blocking level complete, the polymer was then stored in a closed container at 70° C. in a heating cabinet overnight. NCO content (1 d): 0.15%

Viscosity (1 d): 1210 Pa*s at 25° C., 373 Pa*s at 50° C.

In examples 3 and 4 (SM5 and SM6) and comparative examples 1 to 2 (SM1 and SM2), the molar ratio of hydroxyl groups in the PTMEG to the isocyanate groups in the polyisocyanate(s) was 1:2. In examples 1 and 2 (SM3 and SM4), the molar ratio of hydroxyl groups in the PTMEG to the isocyanate groups in the polyisocyanate(s) was 1:1.75.

The molar ratio of the OH groups in the Cardolite NC-700 to the isocyanate groups in the isocyanate-terminated polymer was about 1.2:1 in examples 1 to 4 and comparative examples 1 and 2.

In examples 1 and 2, the molar ratio of isocyanate groups in the diisocyanate to the isocyanate groups in the polyisocyanate having 2.5 or more isocyanate groups was about 6:1. In examples 3 and 4, the molar ratio of isocyanate groups in the diisocyanate to the isocyanate groups in the polyisocyanate having 2.5 or more isocyanate groups was about 3:1.

### Examples 5 to 8 and Comparative Examples 3 and 4

The impact modifiers SM1 to SM6 prepared in examples 1 to 4 and comparative examples 1 to 2 were each used for production of adhesives. The constituents and proportions in the adhesives are listed below, using each of the impact modifiers SM3 to SM6 for production of examples 5 to 8 and each of the impact modifiers SM1 and SM2 for production of comparative examples 3 and 4.

| | Parts by | | |
|---|---|---|---|
| Raw material | weight | | Supplier |
| D.E.R 331 | 45.0 | Bisphenol A epoxy resin | Dow |
| PolyPox R7 | 3.0 | Epoxy reactive diluent | Dow |
| Toughener | 15.0 | Impact modifier (one each of | |
| | | SM1 to SM6) | |
| Dyhard 100SF | 4.1 | Hardener | Alzchem |
| Urone accelerator | 0.2 | Hardening accelerator | Alzchem |
| Omyacarb 5GU | 25.0 | Filler | Omya |
| Precal 30S | 5.0 | Desiccant | Kreidewerke |
| | | | Dammann |
| HDK H18 | 3.0 | Thixotropic agent | Wacker |

The respective adhesives were mixed in a batch size of 350 g in a planetary mixer. For this purpose, the above mentioned ingredients were initially charged in a 1.5 L mixing canister and mixed at 150 rpm at 80° C. under reduced pressure and then dispensed into cartridges.

Table 1 once again lists the polyol and polyisocyanate components used for the respective impact modifiers for illustration purposes. The equivalence figures for the isocyanate groups are based here on the ratio relative to 1 equivalent of hydroxyl groups of the PTMEG.

Directly after mixing of the adhesive formulation, the properties thereof were determined by the test methods which follow. The results are likewise reported in table 1.

TABLE 1

| Adhesive | | Comp. ex. 3 | Comp. ex. 4 | Ex. 5 | Ex. 6 | Ex. 7 | Ex. 8 |
|---|---|---|---|---|---|---|---|
| Toughener | | SM1 | SM2 | SM3 | SM4 | SM5 | SM6 |
| Polyol | | Terathane | Terathane | Terathane | Terathane | Terathane | Terathane |
| | | 2000 | 2000 | 2000 | 2000 | 2000 | 2000 |
| Isocyanate | | IPDI | HDI | IPDI(1.5 eq), | IPDI (1.5 eq), | IPDI (1.5 eq), | IPDI (1.5 eq), |
| | | (2.0 eq) | (2.0 eq) | Vestanat | Bayhydur | Bayhydur | Desmodur |
| | | | | HB2640/100 | 304 | 3100 | N3600 |
| | | | | (0.25 eq) | (0.25 eq) | (0.5 eq) | (0.5 eq) |
| Elongation at break | [%] | 2 | 6 | 3 | 7 | 3 | 6 |
| Modulus of elasticity | [MPa] | 1890 | 2270 | 2270 | 2090 | 1920 | 1790 |
| (0.05%-0.025%) | | | | | | | |
| LSS | | | | | | | |
| Standard | [MPa] | 33.2 | 33.5 | 29.8 | 33.0 | 34.9 | 36.1 |
| Underhardening | [MPa] | 21.6 | 21.8 | 26.5 | 25.5 | 33.3 | 33.8 |
| Overhardening | [MPa] | 17.4 | 17.3 | 19.1 | 22.6 | 33.1 | 30.5 |
| Angular peel | [N/mm] | 4.5 | 3.0 | 5.4 | 5.0 | 7.6 | 6.9 |
| resistance | | | | | | | |
| Impact peel resistance | [N/mm] | | | | | | |
| +23° C. | | 13.2 ± 1.6 | 9.4 ± 0.2 | 22.3 ± 0.8 | 19.4 ± 0.8 | 29.6 ± 1.0 | 26.6 ± 0.8 |
| −30° C. | | 6.0 ± 0.8 | 6.3 ± 1.1 | 14.9 ± 0.44 | 13.8 ± 0.1 | 17.7 ± 0.3 | 19.4 ± 0.7 |
| Viscosity | [Pa · s] | | | | | | |
| 25° C. | | 220 | 225 | 331 | 330 | 312 | 329 |
| 50° C. | | 84 | 79 | 89 | 76 | 72 | 72 |

### Tensile Strength, Elongation at Break and Modulus of Elasticity (DIN EN ISO 527)

An adhesive sample was pressed between two Teflon papers to a layer thickness of 2 mm. After curing at 180° C. for 30 min, the Teflon papers were removed and the specimen was punched out according to the DIN standard state. The test specimens were tested under standard climatic conditions at a pulling speed of 2 mm/min. Tensile strength, elongation at break and 0.05%-0.25% modulus of elasticity were determined according to DIN EN ISO 527.

### Lap Shear Strength (LSS) (DIN EN 1465)

100×25 mm test sheets of DC04 EG steel (thickness 0.8 mm) which have been cleaned and reoiled with Anticorit PL 3802-39S were bonded with the adhesive compositions described over a bonding area of 20×30 mm with glass beads as spacers in a layer thickness of 0.3 mm and cured under the curing conditions specified.

Curing conditions: a) 35 min at oven temperature 175° C. (standard), b) 15 min at oven temperature 160° C. (underhardening), c) 30 min at oven temperature 210° C. (overhardening). Lap shear strength was determined on a tensile tester at a pulling speed of 10 mm/min in a quintuplicate determination according to DIN EN 1465.

### Angular Peel Strength (DIN 53281)

130×25 mm test sheets of DC-04 EG steel (thickness 0.8 mm) were prepared. Test sheets were bent(90°) at a level of 30 mm with a suitable punching machine. The cleaned areas of 100×25 mm that had been reoiled with Anticorit PL 3802-39S were bonded with the adhesive compositions described with glass beads as spacers in a layer thickness of 0.3 mm and cured under standard conditions (35 min, oven temperature 175° C.). Angular peel strength was determined on a tensile tester with a pulling speed of 10 mm/min in a triple determination as the peel force in N/mm in the region of the traverse length from ⅙ to ⅚ of the path length.

### Impact Peel Resistance (According to ISO 11343)

The specimens were produced with the example adhesive composition described and DC04 EG steel with dimensions of 90×20×0.8 mm. The bond area was 20×30 mm at a layer thickness of 0.3 mm with glass beads as spacers. The impact peel resistance was measured at each of the temperatures specified as a triple determination with a Zwick 450 impact pendulum. The impact peel resistance reported is the averaged force in N/mm under the measurement curve from 25% to 90% according to ISO11343.

### Viscosity

Viscosity measurements on the adhesives were effected 1 d after production on an

MCR 101 rheometer from the manufacturer Anton Paar by a rotation method using a plate-plate geometry at a temperature of 25° C. or 50° C. with the following parameters: 5 Hz, 1 mm gap, plate-plate separation 25 mm, 1% deformation.

1. An impact modifier which is an isocyanate-terminated polymer, the isocyanate groups of which have been fully or partly blocked by reaction with a blocking agent, wherein
the isocyanate-terminated polymer is a reaction product of
a) one or more polyols comprising polytetramethylene ether glycol in a proportion of at least 95% by weight, based on the total weight of the polyols, and
b) two or more polyisocyanates including at least one diisocyanate and at least one polyisocyanate having a mean isocyanate functionality of 2.5 or more,
wherein the molar ratio of isocyanate groups in the diisocyanate(s) to isocyanate groups in the polyisocyanate(s) having a mean isocyanate functionality of 2.5 or more is in the range from 2:1 to 20:1.

2. The impact modifier as claimed in claim 1, wherein the molar ratio of isocyanate groups in the diisocyanate(s) to isocyanate groups in the polyisocyanate(s) having a mean isocyanate functionality of 2.5 or more is in the range from 2.5:1 to 10:1.

3. The impact modifier as claimed in claim 1, wherein the diisocyanate is an aliphatic diisocyanate.

4. The impact modifier as claimed in claim 1, wherein the polyisocyanate having a mean isocyanate functionality of 2.5 or more is selected from isocyanurates, biurets, iminooxadiazines and allophanates of diisocyanates.

5. The impact modifier as claimed in claim 1, wherein the polytetramethylene ether glycol has a mean molecular weight in the range from 1000 to 3000 g/mol.

6. The impact modifier as claimed in claim 1, wherein, based on the polyol(s) and the polyisocyanates, the molar ratio of isocyanate groups to hydroxyl groups is in the range from 3:1 to 3:2.

7. The impact modifier as claimed in claim 1, wherein at least 80% of the isocyanate groups in the isocyanate-terminated polymer have been blocked.

8. The impact modifier as claimed in claim 1, wherein the blocking agent is selected from a compound having at least one aliphatic or aromatic hydroxyl group, a compound having at least one secondary amino group, a compound having at least one oxime group, and a compound having at least one CH-acidic group.

9. The impact modifier as claimed in claim 1, wherein the blocking agent is selected from alcohols, phenols and bisphenols.

10. A process for preparing an impact modifier, comprising
A) the reaction of
a) one or more polyols comprising polytetramethylene ether glycol in a proportion of at least 95% by weight, based on the total weight of the polyols, and
b) two or more polyisocyanates including at least one diisocyanate and at least one polyisocyanate having a mean isocyanate functionality of 2.5 or more, optionally in the presence of a catalyst, where the molar ratio of isocyanate groups in the diisocyanate(s) to isocyanate groups in the polyisocyanate(s) having a mean isocyanate functionality of 2.5 or more is in the range of 2:1 to 20:1, to form an isocyanate-terminated polymer, and
B) reacting the isocyanate-terminated polymer with a blocking agent optionally in the presence of a catalyst, in order to partly or fully block the isocyanate groups of the isocyanate-terminated polymer.

11. The process as claimed in claim 10, wherein the impact modifier is an isocyanate-terminated polymer, the isocyanate groups of which have been fully or partly blocked by reaction with a blocking agent, wherein
the isocyanate-terminated polymer is a reaction product of
a) one or more polyols comprising polytetramethylene ether glycol in a proportion of at least 95% by weight, based on the total weight of the polyols, and
b) two or more polyisocyanates including at least one diisocyanate and at least one polyisocyanate having a mean isocyanate functionality of 2.5 or more,
wherein the molar ratio of isocyanate groups in the diisocyanate(s) to isocyanate groups in the polyisocyanate(s) having a mean isocyanate functionality of 2.5 or more is in the range from 2:1 to 20:1.

12. The process as claimed in claim 10, wherein, in step B), the molar ratio of isocyanate groups in the isocyanate-terminated polymer to H-acidic groups in the blocking agent is in the range from 1:1 to 2:3.

13. A method comprising preparing a one-component or two-component epoxy resin composition with an impact modifier as claimed in claim 1.

14. A one-component or two-component epoxy resin composition comprising
a) at least one epoxy resin,
b) at least one hardener for epoxy resins and
b) an impact modifier as claimed in claim 1,
wherein the epoxy resin composition is a one-component epoxy resin adhesive.

15. The epoxy resin composition as claimed in claim 14, in which the proportion of the impact modifier is within a range from 5% to 60% by weight.
